(19) United States
(12) Patent Application Publication
(10) Pub. No.: US 2025/0101275 A1
(43) Pub. Date: Mar. 27, 2025

(54) PUMPABLE, ONE-COMPONENT, HIGH WASH RESISTANT, ANTI-FLUTTER COMPOSITIONS FOR USE IN AUTOMOTIVE APPLICATIONS

(71) Applicants: Thanikaivelan Tindivanam Veeraraghavan, Newburgh, IN (US); Senthilkumar Veeraraghavan, Newburgh, IN (US); Karthikeyan Sengotaiyan, Newburgh, IN (US)

(72) Inventors: Thanikaivelan Tindivanam Veeraraghavan, Newburgh, IN (US); Senthilkumar Veeraraghavan, Newburgh, IN (US); Karthikeyan Sengotaiyan, Newburgh, IN (US)

(21) Appl. No.: 18/372,736

(22) Filed: Sep. 26, 2023

(51) Int. Cl. C09J 109/06; C09J 11/04; C09J 11/08

(52) U.S. Cl. CPC C09J 109/06; C09J 11/04; C09J 11/08; C09J 2203/354

(57) ABSTRACT

A pumpable, one-component, curable, anti-flutter composition which cures to form a cured product, including: (a) an elastomer; (b) a homopolymer resin; (c) a novel thixotropic filler system; and (d) wherein the anti-flutter composition exhibits high wash resistance.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to automotive sealants, and, more particularly, to pumpable, one-component, high wash resistant, anti-flutter sealants that are used to adhere to and isolate, for example, outer panels (e.g., hoods, A-pillars, B-pillars, C-pillars, roofs, doors, deck lids, etcetera) from inner panels/reinforcement. These outer panels are required to adhere to steel, aluminum, metal alloys, and carbon fiber-reinforced polymer (CFRP) substrates that, often times, have stamping lubricant coated on their surfaces. As such, these substrate surfaces can be very slippery making it difficult to apply and maintain anti-flutter sealants thereto. Anti-flutter sealants are also commonly used in the automotive industry to seal or fill in the gaps between the body panels of the automobile, and are routinely applied in areas where the frame of the automobile has joints to prevent and/or minimize water, dust, air intrusion, noise, vibration and corrosion.

The anti-flutter sealant formulations of the present invention are single component, room temperature pumpable, heat curable compositions that utilize a novel thixotropic filler system that enables excellent high wash resistance in both the uncured and the cured states. Such high wash resistance allows the uncured anti-flutter composition on the body panels to go through multiple aqueous rinses and other steps prior to curing during the manufacturing process, including, but not limited to those identified in FIG. 1.

### 2. Background Art

Anti-flutter sealants and formulations have been known in the art for years and are the subject of a plurality of patents and publications, including: U.S. Pat. No. 10,982,116 entitled “Adhesive and Damping Film,” U.S. Pat. No. 7,838,589 entitled “Sealant Material,” U.S. Pat. No. 7,271,202 entitled “Reactive Hot Melt Adhesive,” U.S. Pat. No. 4,978,474 entitled “Sealant,” U.S. Pat. No. 4,600,745 entitled “Adhesive Compositions,” U.S. Pat. No. 4,569,382 entitled “Composite of Rubber and Metal Reinforcement Therefor,” U.S. Pat. No. 3,873,348 entitled “Paintable Rubber Composition and Products,” U.S. Pat. No. 3,872,548 entitled “Sealant,” United States Patent Application Publication Number 2005/0187332 entitled “Rubber Composition,” and Chinese Patent Number CN110643306 entitled “Special Rubber Type Spot Welding Sealant for Body-in-White and Preparation Method Thereof”—all of which are hereby incorporated herein by reference in their entirety including all references cited therein.

U.S. Pat. No. 10,982,116 appears to disclose adhesives having (a) a polyester at 20 to 50 weight percent, (b) a first tackifier at 30 to 60 weight percent, and (c) a first olefin-styrene block copolymer at 5 to 30 weight percent. The polyester has a glass transition temperature between −40° C. and −10° C., and the adhesive has a heat activation temperature between 20° C. and 100° C. The '116 patent discloses damping films having at least one layer of the adhesive and a foamed layer. The foamed layer includes a second olefin-styrene block copolymer at 30 to 80 weight percent and a second tackifier at 15 to 60 weight percent.

U.S. Pat. No. 7,838,589 appears to disclose a sealant material for providing a seal between a substrate and an interface. The sealant material may also include a material, shape, ingredient or otherwise for inhibiting the flow of bubbles throughout the material. The sealant material disclosed in the '589 patent comprises: (a) an acrylate copolymer from about 30% to about 70% by weight of the sealant material; (b) an acetate copolymer from about 1% to about 10% by weight of the sealant material; (c) an epoxy resin from about 2% to about 50% by weight of the sealant material; (d) masses of blocking material; (e) one or more curing agents from about 0.0% to about 7% by weight of the sealant material; and (f) one or more fillers from about 5% to about 60% by weight of the sealant material.

U.S. Pat. No. 7,271,202 appears to disclose a reactive hot melt composition which has adhesion and curing properties, and can be formulated into free-flowing pellets or beads, by using an ethylene-acrylic acid copolymer, and ethylene-methacrylic acid copolymer, and/or an ethylene-acrylic acid methacrylic acid terpolymer as a component of the composition along with free radical crosslinking initiators. The incorporation of a foaming agent enables the production of compositions which are useful in space-filling applications, (i.e., as so-called “anti-flutter” compositions).

U.S. Pat. No. 4,978,474 appears to disclose a heat pumpable expandable weld through sealant which comprises a combination of a terpolymer and a copolymer, a curing agent, electrically conductive particles and a blowing agent. Also disclosed in the '474 patent is a method of bonding two metal components using this sealant.

U.S. Pat. No. 4,600,745 appears to disclose an adhesive composition for filling gaps and sealing joints in engineering assembly that includes a blend of 100 parts by weight of a liquid polybutadiene polymer having an average molecular weight from 1,000 Daltons and a viscosity from 2 to 800 dPas at 25° C., at least 40 percent of the unsaturation having a 1,4 configuration, preferably cis 1,4,5 to 60 parts of powdered sulphur, 2.5 to 70 parts of an organic accelerator or accelerators, and up to 80 percent by weight of an inert filler(s). The adhesive composition may also include promoters, desiccants, blowing agents and/or solid rubber, preferably solid polybutadiene.

U.S. Pat. No. 4,569,382 appears to disclose a composite of rubber composition containing zinc oxide, carbon black, optional and/or mineral fillers, cure accelerator(s), fatty acid and/or metal salts thereof, and filament reinforcement therefor, where said rubber composition is sulfur-cured with said reinforcement and where said reinforcement is selected from at least one of metal, organic and inorganic filaments, optionally a multiple of filaments cabled together to form a cord characterized in that said rubber composition contains (a) from about 0.1 to about 10 phr of at least one borate as the product of (i) a metal selected from Group IA, IIA, IIB, IVA, IVB and VIII of the Perodic Table of Elements, and (ii) an acid selected from boric, orthoboric, metaboric or polyboric acid, and (b) about 0.2 to about 5 phr of at least one monomer (cross-linkable) containing at least two —CH═CH₂ units selected from at least one of triallyl phosphate, triallyl phosphite, triallyl trimellitate, diallyl phthalate, diallyl isophthalate, ethylene glycol dimethacrylate, trimethylol propane trimethacrylate, divinyl benzene, diallyl adipate, N,N′-diallyl lelamine, diallyl malonate, diallyl sebacate, diallyl suberate, diallyl succinate, diallyl terephthalate, triallyl borate, N,N′,n″-triallyl citric triamide, N,N′-diallyl acrylamide, diallyl azelate, diallyl adipate, diallyl chlorendate, diallyl diglycolate, dialyl diglycol carbonate, diallyl dodecadioate, diallyl fumarae, diallyl glutarate, diallyl maleate and dialyl oxalate.

U.S. Pat. No. 3,873,348 appears to disclose a paintable rubber composition made of a special formulation of materials including, for example, an SBR rubber elastomer and a special thermoplastic polymeric stiffening agent which provides the cured composition with a high flex modulus. Also, the cured composition is operative to prevent the final product formed therewith from fluttering and/or sagging during automotive usage and the cured composition or product is resilient and recoverable to its original shape after deflection.

U.S. Pat. No. 3,872,548 appears to disclose a sealant particularly adapted for use on automobile bodies to seal joints. A typical composition of the sealant is: Kraton 4113 42.1% by weight blocked SBR, Piccotex 100 13.5% vinyl toluene-alpha methyl styrene copolymer, Camelwite Whiting 42.1%, calcium carbonate Regal 660R 1.7%, furnace black Plastanox 2246 0.4% and antioxidant Plastanox LTDP 0.2%.

United States Patent Application Publication Number 2005/0187332 appears to disclose a rubber composition, in which reaction efficiency of the silane coupling agent in kneading is improved, generation of bubbles is suppressed, abrasion resistance is improved and rolling resistance is reduced. Specifically, the rubber composition comprises silica and 3 to 15 parts by weight of a silane coupling agent and 1.5 to 15 parts by weight of a potassium salt based on 100 parts by weight of the silica.

Chinese Patent Number CN110643306 appears to disclose a rubber type sealant for a body-in-white which comprises the following components in parts by weight: (a) 45-55% of mixed rubber, (b) 4.5-5.5% of titanium dioxide, (c) 18-22% of ground calcium carbonate, (d) 9-11% of nano calcium carbonate, (e) 0.27-0.33% of rubber vulcanizing agent, (f) 2.7-3.3% of diluent, (g) 0.27-0.33% of vulcanization accelerator, (h) 2.7-3.3% of tackifier, (i) 3.6-4.4% of liquid flame retardant and (j) 4.0-5.5% of conductive carbon black. The mixed rubber comprises the following components in parts by weight: (1) 12.6-15.4% of butadiene rubber, (2) 12.6-15.4% of nitrile rubber, (3) 25.2-30.8% of styrene butadiene rubber, (4) 27-33% of liquid polybutadiene, (5) 4.5-5.5% of heavy calcium carbonate, (6) 4.5-5.5% of common light calcium carbonate and (7) 3.8-4.4% of anti-aging agent. The rubber type sealant disclosed by the invention takes the mixed rubber as a master batch, does not use a component containing PVC (polyvinyl chloride), ensures that no corrosive component volatilizes in the spot welding process, uses a halogen-free liquid flame retardant and acetylene conductive carbon black, achieves the purposes of flame retardance and conductivity without increasing the viscosity and introducing other conductive substances, and is environment-friendly because the formula does not contain an organic solvent.

While the above-identified patents and publications do appear to disclose various sealants and anti-flutter compositions, their formulations remain non-desirous and/or problematic inasmuch as, among other things, none of the above-identified anti-flutter compositions are single component, room temperature pumpable, and heat curable that, among other things, offer excellent high wash resistance in both the uncured and cured states.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a pumpable, one-component, curable, anti-flutter composition which cures to form a cured product, comprising, consisting essentially of, and/or consisting of: (a) an elastomer; (b) a homopolymer resin; and (c) a novel thixotropic filler system, wherein the anti-flutter composition exhibits high wash resistance in the uncured state. The present invention is also directed to a cured product formed using the one-component, anti-flutter composition disclosed herein.

The present invention is further directed to a pumpable, one-component, curable, anti-flutter composition which cures to form a cured product, comprising, consisting essentially of, and/or consisting of: (a) an elastomer; (b) a PVC resin; (c) a blowing agent; (d) a plasticizer; (e) a curing agent; (f) an adhesion promoter; (g) an optional pigment; (h) a wetting agent; and (i) a novel thixotropic filler system, wherein the anti-flutter composition exhibits high wash resistance in the uncured state.

In a preferred embodiment of the present invention, the elastomer comprises a styrene-butadiene rubber present from approximately 5.0 percent to approximately 30.0 percent of the total weight of the composition.

In another preferred embodiment of the present invention, the elastomer comprises a crosslinked styrene-butadiene rubber terpolymer present from approximately 5.0 percent to approximately 30.0 percent of the total weight of the composition.

In yet another preferred embodiment of the present invention, the PVC resin is present from approximately 5.0 percent to approximately 20.0 percent of the total weight of the composition.

In one preferred embodiment of the present invention, the blowing agent comprises azodicarbonamide and/or methyl cyanoacrylate present from approximately 0.1 percent to approximately 5.0 percent of the total weight of the composition.

In a preferred implementation of the present invention, the plasticizer comprises diisononyl phthalate (DINP), diisodecyl phthalate (DIDP), and/or diisoundecyl phthalates (DIUP) present from approximately 10.0 percent to approximately 45.0 percent of the total weight of the composition.

In yet another preferred implementation of the present invention, the curing agent comprises a substituted urea present from approximately 1.0 percent to approximately 10.0 percent of the total weight of the composition.

In one preferred implementation of the present invention, the adhesion promoter comprises a bisphenol A liquid epoxy resin present from approximately 1.0 percent to approximately 10.0 percent of the total weight of the composition.

In a preferred embodiment of the present invention, the optional pigment comprises titanium dioxide present from approximately 0.1 percent to approximately 5.0 percent of the total weight of the composition.

In another preferred embodiment of the present invention, the wetting agent comprises petroleum distillates, poly(oxy-1,2-ethanediyl)-alphas-(3-carboxy-1-oxypropyl)-omega-(tridecyloxy)-(acidic ester), and/or poly(oxy-1,2-ethanediyl)-alphas-(3-carboxy-1-oxypropyl)-omega (penta-decyloxy)-(acidic ester) present from approximately 0.1 percent to approximately 5.0 percent of the total weight of the composition.

In yet another preferred embodiment of the present invention, the novel thixotropic filler system comprises one or more of the following ground calcium carbonate, coated calcium carbonate, multi-mineral clay, polyamide wax, a solution of polyhydroxycarboxylic acid amides, and fumed silica treated with polydimethyisiloxane. In this embodiment, the novel thixotropic filler system is preferably present from approximately 10.0 percent to approximately 45.0 percent of the total weight of the composition.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is flow diagram of an automotive body shop/paint shop indicating where in the manufacturing process anti-flutter compositions of the present invention are utilized (see dashed line box);

FIG. 2 of the drawings is a cross-sectional schematic representation of a component assembly (e.g., an automobile component sub-assembly) associated with anti-flutter composition of the present invention;

FIG. 3 of the drawings is a two-dimensional graph showing pressure flow viscosity as a function of temperature for Experiments 1-6;

FIG. 4 of the drawings is a two-dimensional graph showing low shear rate as a function of time for Experiments 1-6;

FIG. 5 of the drawings is a two-dimensional graph showing high shear rate as a function of time for Experiments 1-6;

FIG. 6 of the drawings is a two-dimensional graph comparing viscosity and low/high shear for Experiments 1-6;

FIGS. 7-12 are two-dimensional graphs showing viscosity as a function of time, via oscillational measurement, for Experiments 1-6, respectively;

FIG. 13 of the drawings is a two-dimensional graph showing storage modulus as a function of time for Experiments 1-6;

FIG. 14 are photographs showing Sag resistance (time 0 and time 60 minutes at STP) for Experiments 1-6;

FIGS. 15-16 are photographs showing wash resistance performance using the rotational method for Experiments 1-6; and

FIG. 17 are photographs showing wash resistance performance using direct impingement spray for Experiments 1-6.

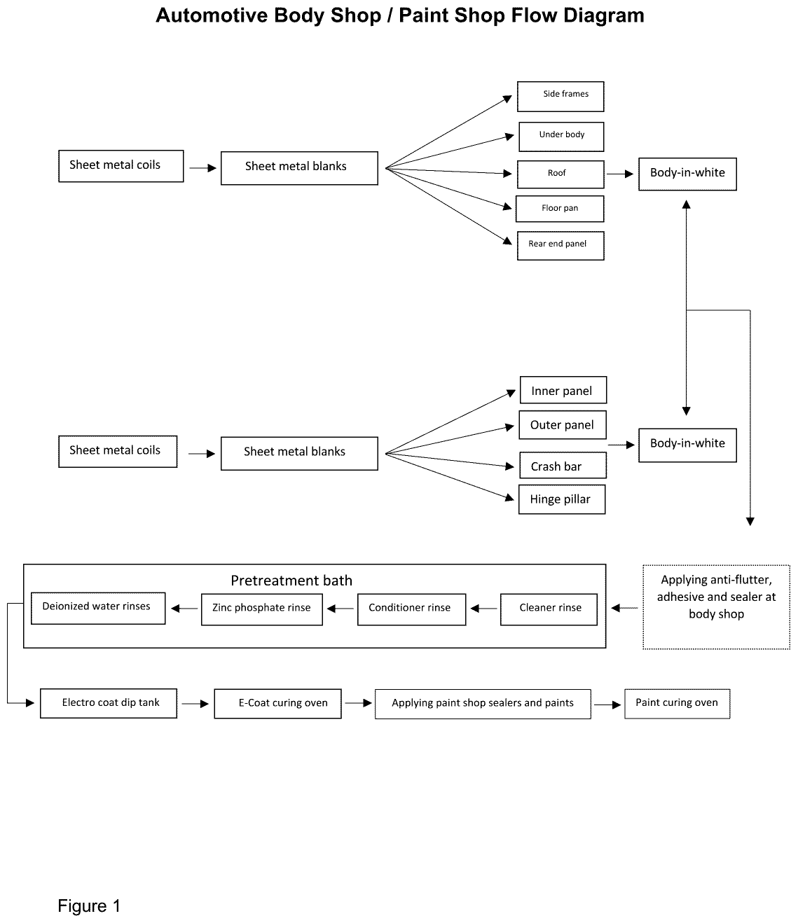

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

As will be discussed and shown experimentally hereinbelow, the present invention is directed to one-component, room temperature pumpable (standard temperature and atmospheric pressure), curable, anti-flutter compositions which cure to form cured products. The anti-flutter compositions of the present invention utilize a novel thixotropic filler system that provides for high wash resistance in both the cured and uncured states.

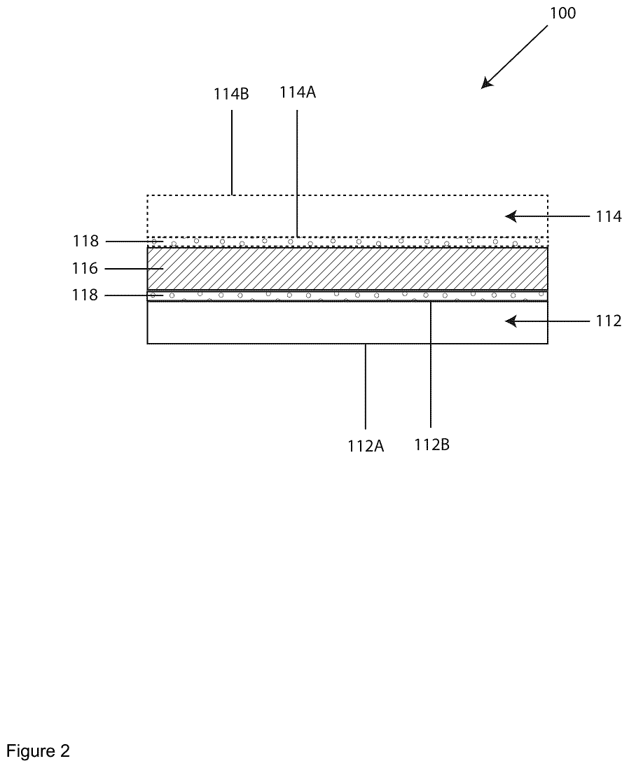

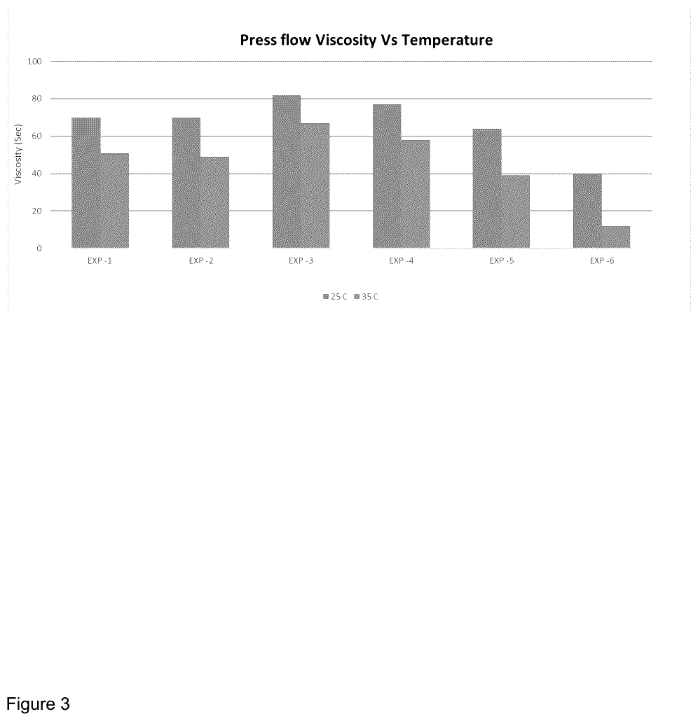

Referring now to the drawings, and to FIG. 2 in particular, component assembly 100 is shown, which generally comprises first substrate 112 having first surface 112A and second surface 112B, optional second substrate 114 having first surface 114A and second surface 114B, and cured anti-flutter composition or product 116. It will be understood that component assembly 100 may comprise, for illustrative purposes only, a variety of areas in automobile bodies, such as interior panels, roof panels, floor panels, firewalls, trunk compartment panels, hood, and in between the inner and outer panels of doors, under body, wheel arcs, etcetera. It will be further understood that cured anti-flutter composition 116 may be applied to a single substrate/panel (112) and/or sandwiched between two substrates/panels (112, 114). For purposes of the present disclosure, surface 112B of substrate 112 (and if present surface 114A of substrate 114) is/are typically coated with oil 118, such as mineral oil, crude oil, refined oil, and/or other petroleum and non-petroleum products used for lubrication and/or corrosion resistance during product fabrication, warehousing, storage, production, etcetera. Oil 118 may comprise a continuous, intermittent, and/or spotted layer on the substrate. Anti-flutter composition 116 adheres to the substrate and exhibits excellent wash resistance—even in the presence of oil 118.

First substrate 112 may be fabricated from any one of a number of materials, such as, for example, steel, steel electrogalvanized with zinc, steel hot dipped galvanized with zinc, aluminum, metal alloys, d-block metals, and combinations thereof. First substrate 112 may also be fabricated from, for example, borosilicate glass, soda lime glass, float glass, natural and synthetic polymeric resins, plastics, and/or composites including Topas®, which is commercially available from Ticona of Summit, New Jersey. First substrate 112 is preferably fabricated from a sheet having a thickness ranging from approximately 0.25 mm to approximately 5.00 mm, and more preferably ranging from approximately 0.75 mm to approximately 2.50 mm. It will be understood, that unless specified otherwise, the term approximately, as used herein, will be defined as the value, number, and/or integer +/−10 percent. Of course, the thickness of the substrate will depend largely upon the particular application of the assembly. While particular substrate materials have been disclosed, for illustrative purposes only, it will be understood that numerous other substrate materials are likewise contemplated for use—so long as the materials exhibit appropriate physical properties, such as strength, to be able to operate effectively in conditions of intended use. Indeed, substrate assemblies in accordance with the present invention can be, during normal operation, exposed to extreme temperature variation, as well as substantial UV radiation, emanating primarily from the sun.

Optional second substrate 114 may be fabricated from similar and/or dissimilar materials as that of first substrate 112. As such, second substrate 114 may comprise polymers, metals, glass, and ceramics—to name a few. Second substrate 114 is preferably fabricated from a sheet having a thickness ranging from approximately 0.25 mm to approximately 5.00 mm, and more preferably ranging from approximately 0.75 mm to approximately 2.50 mm.

As will be discussed herein below, anti-flutter composition 116 is preferably fabricated from: (1) an elastomer; (2) a homopolymer resin/PVC resin; (3) a blowing agent; (4) a plasticizer; (5) a curing agent; (6) an adhesion promoter; (7) an optional pigment; (8) a wetting agent; (9) a thixotropic filler system; and (10) any adjunct agents.

Components of the curable dampening composition of the present invention are provided below.

The room temperature pumpable, one-component, curable, anti-flutter compositions of the present invention preferably include an elastomeric and/or rubber component. Suitable examples include foam rubbers, natural rubbers, polyisoprene rubbers, acrylonitrile-butadiene rubbers (NBR), styrene-butadiene rubbers (SBR), ethylene-vinyl acetate (EVA) copolymers, polybutadiene rubbers, styrene-butadiene-styrene (SBS) rubbers, crosslinked styrene-butadiene rubber terpolymer, styrene-ethylene-propylene-styrene (SEPS) copolymer rubbers, styrene-isoprene-styrene (SIS) copolymer rubbers, synthetic/natural isoprene rubbers, butyl rubbers, and combination thereof. These components may be used alone or in any combination of two or more together.

Provided below are non-limiting examples of structural formulas for certain rubbers suitable for use in accordance with the present invention:

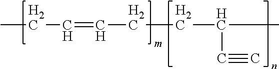

wherein m and n are independent integers ranging from 1 to 50,000, and more preferably from approximately 3,500 to approximately 17,500. Preferably, the ratio of m to n ranges from 1:1 to 1:7, and more preferably 1:1 to 1:4;

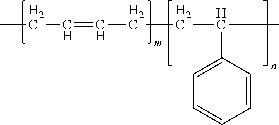

wherein m and n are independent integers ranging from 1 to 35,000, and more preferably from approximately 3,750 to approximately 15,750. Preferably, the ratio of m to n ranges from 1:1 to 1:5, and more preferably 1:1 to 1:3.

In a preferred embodiment of the present invention, the anti-flutter composition comprises an elastomeric material having a solid nitrile group-containing copolymer rubber or styrene butadiene copolymer rubber. Preferably, the styrene containing copolymer is already pre-crosslinked by divinyl benzene and is highly cross-linked. Preferably, the styrene content is approximately 20 percent to approximately 30 percent by weight of the total copolymer weight. In one embodiment, the pre-crosslinked styrene butadiene copolymer has a molecular weight of greater than approximately 250,000 Daltons, and Mooney viscosity ranging from approximately 30 to approximately 40 at standard temperature and pressure (STP).

Preferably, the elastomer is present from approximately (i.e., +/−5%) 5.0 percent to approximately (i.e., +/−5%) 30.0 percent of the total weight of the composition, and more preferably present from approximately (i.e., +/−5%) 10.0 percent to approximately (i.e., +/−5%) 20.0 percent of the total weight of the composition.

The room temperature pumpable, one-component, curable, anti-flutter compositions of the present invention preferably include a resin/homopolymer resin/PVC resin. In a preferred embodiment of the present invention, the anti-flutter compositions comprise a PVC homopolymer or copolymer, such as Vestolit G 121 A which is commercially available from Mexichem Specialty Resins, Inc. In another embodiment, the resin comprises poly(vinyl chloride), poly(vinyl acetate), copolymers of vinyl chloride, vinyl acetate and mixtures thereof.

In yet another preferred embodiment of the present invention, the PVC homopolymer and copolymer are represented by the following chemical structures:

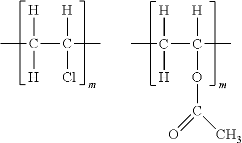

wherein m is an integer such that the average molecular weight of the homopolymers and copolymers range from approximately 60,000 to approximately 200,000.

Preferably, the homopolymer resin/PVC resin is present from approximately (i.e., +/−5%) 5.0 percent to approximately (i.e., +/−5%) 20.0 percent of the total weight of the composition, and more preferably present from approximately (i.e., +/−5%) 10.0 percent to approximately (i.e., +/−5%) 15.0 percent of the total weight of the composition.

The room temperature pumpable, one-component, curable, anti-flutter compositions of the present invention preferably include a blowing agent. In a preferred embodiment of the present invention, the blowing agent comprises azodicarbonamides, methyl cyanoacrylate, p,p′-oxybis(benzene-sulfonyl) hydrazide, p-toluene sulfonyl hydrazide, and dinitroso pentamethylene tertamine. In one preferred embodiment, the blowing agent comprises an azo compound-based blowing agent, a sulfonyl hydrazide compound-based blowing agent, and/or an amide compound-based blowing agent.

Preferably, the blowing agent is present from approximately (i.e., +/−5%) 0.1 percent to approximately (i.e., +/−5%) 5.0 percent of the total weight of the composition, and more preferably present from approximately (i.e., +/−5%) 0.75 percent to approximately (i.e., +/−5%) 2.0 percent of the total weight of the composition.

The room temperature pumpable, one-component, curable, anti-flutter compositions of the present invention preferably include one or more plasticizers represented by at least one of the following chemical structures and derivatives thereof:

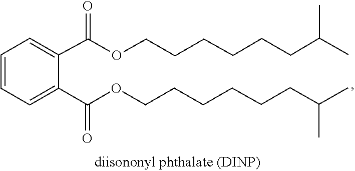 [SMILES: CC(C)CCCCCCOC(=O)c1ccccc1C(=O)OCCCCCCC(C)C]

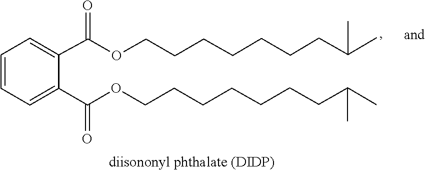 [SMILES: CC(C)CCCCCCCOC(=O)c1ccccc1C(=O)OCCCCCCCC(C)C]

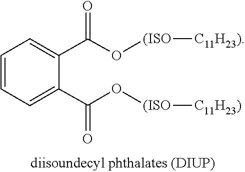

In another preferred embodiment of the present invention, the plasticizer is selected from the group consisting of monomeric esters of phthalic, benzoic, succinic, adipic, sebacic, talic, lauric, azelaic, caprylic, hexanoic, phosphoric, oleic, glutaric, trimellitic and stearic acids, 2,2,4-trimethyl-1,3-pentanediol, citric acid esters, N-ethyl toluene sulfonamide, polymeric esters of succinic, adipic, sebacic, talic, lauric, azelaic, caprylic, hexanoic, benzoic, phthalic, phosphoric, oleic, glutaric, trimellitic and stearic acids, and mixtures thereof.

Preferably, the plasticizer is present from approximately (i.e., +/−5%) 10.0 percent to approximately (i.e., +/−5%) 45.0 percent of the total weight of the composition, and more preferably present from approximately (i.e., +/−5%) 20.0 percent to approximately (i.e., +/−5%) 35.0 percent of the total weight of the composition.

The room temperature pumpable, one-component, curable, anti-flutter compositions of the present invention preferably include one or more curing agents. In a preferred embodiment of the present invention, the curing agents comprise ZnO, CaO, dicyandiamide, and/or substituted urea.

Preferably, the curing agent is present from approximately (i.e., +/−5%) 1.0 percent to approximately (i.e., +/−5%) 10.0 percent of the total weight of the composition, and more preferably present from approximately (i.e., +/−5%) 3.0 percent to approximately (i.e., +/−5%) 7.5 percent of the total weight of the composition.

The room temperature pumpable, one-component, curable, anti-flutter compositions of the present invention preferably include one or more adhesion promoters. In a preferred embodiment of the present invention, the adhesion promoters comprise one or more bisphenol A type liquid epoxy resins. In one embodiment of the present invention, the bisphenol A type liquid epoxy resin preferably comprises a diglycidyl ether of bisphenol A. Non-limiting examples of bisphenol A type liquid resins include DER 330 (Olin Corporation), DER 331 (Olin Corporation), DER 332 (Olin Corporation), DER 383 (Olin Corporation), DER 3171 (Olin Corporation), DER 317 (Olin Corporation), DER 321 (Olin Corporation), DER 3212 (Olin Corporation), DER 322 (Olin Corporation), DER 323 (Olin Corporation), DER 324 (Olin Corporation), DER 325 (Olin Corporation), DER 326 (Olin Corporation), DER 3274 (Olin Corporation), DER 333 (Olin Corporation), DER 3401 (Olin Corporation), DER 346 (Olin Corporation), DER 362 (Olin Corporation), and EPON 825 (Miller-Stephenson).

In a preferred embodiment of the present invention, the bisphenol A diglycidyl ether epoxy resin is represented by the following chemical structure and derivatives thereof:

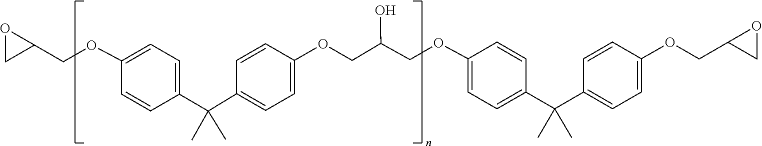

wherein n is 0 or an integer ranging from 1 to approximately 25.

In one preferred embodiment of the present invention, the adhesion promoters comprise one or more bisphenol A liquid epoxy resins present from approximately (i.e., +/−5%) 1.0 percent to approximately (i.e., +/−5%) 10.0 percent of the total weight of the composition, and more preferably present from approximately (i.e., +/−5%) 1.0 percent to approximately (i.e., +/−5%) 7.0 percent of the total weight of the composition.

The room temperature pumpable, one-component, curable, anti-flutter compositions of the present invention preferably include one or more pigments. Pigments may include non-elemental pigments and elemental pigments, such as, but not limited to, cadmium pigments (e.g., cadmium yellow, cadmium red, cadmium green, cadmium orange, cadmium sulfoselenide, etcetera), chromium pigments (e.g., chrome yellow and chrome green (viridian)), cobalt pigments (e.g., cobalt violet, cobalt blue, cerulean blue, aureolin (cobalt yellow)), copper pigments (e.g., azurite, han purple, han blue, egyptian blue, malachite, paris green, phthalocyanine blue BN, phthalocyanine green, verdigris) iron oxide pigments (e.g., sanguine, caput mortuum, oxide red, red ochre, yellow ochre, venetian red, prussian blue, raw sienna, burnt sienna, raw umber, burnt umber), lead pigments (e.g., lead white, cremnitz white, naples yellow, red lead, lead-tin-yellow), manganese pigments (e.g., manganese violet, YInMn blue), mercury pigments (e.g., vermilion), titanium pigments (e.g., titanium yellow, titanium beige, titanium white (TiO₂), titanium black), zinc pigments (e.g., zinc white, zinc ferrite, zinc yellow), aluminum pigment (e.g., aluminum powder), carbon pigments (e.g., carbon black (including vine black, lamp black), ivory black (bone charcoal)), and ultramarine pigments (e.g., (based on sulfur) ultramarine, ultramarine green shade).

Preferably, the pigment is present from approximately (i.e., +/−5%) 0.1 percent to approximately (i.e., +/−5%) 5.0 percent of the total weight of the composition, and more preferably present from approximately (i.e., +/−5%) 1.0 percent to approximately (i.e., +/−5%) 3.4 percent of the total weight of the composition.

The room temperature pumpable, one-component, curable, anti-flutter compositions of the present invention preferably include one or more wetting agents. Non-limiting examples of wetting agents, include at least one of the following petroleum distillates, poly(oxy-1,2-ethanediyl)-alphas-(3-carboxy-1-oxypropyl)-omega-(tridecyloxy)-(acidic ester), and poly(oxy-1,2-ethanediyl)-alphas-(3-carboxy-1-oxypropyl)-omega-(pentadecyloxy)-(acidic ester). Preferred wetting agents of the present invention include, for example, commercially available Tego Disperse 755W, 741W, 653, 670, 652, and 656, BYK 333, 378, 390, 392, and 3750, and DisperBYK 1148.

Preferably, the wetting agent is present from approximately (i.e., +/−5%) 0.1 percent to approximately (i.e., +/−5%) 5.0 percent of the total weight of the composition, and more preferably present from approximately (i.e., +/−5%) 0.1 percent to approximately (i.e., +/−5%) 1.0 percent of the total weight of the composition.

The room temperature pumpable, one-component, curable, anti-flutter compositions of the present invention preferably include a thixotropic filler system/component that comprises one or more of the following: ground calcium carbonate, coated calcium carbonate, multi-mineral clay, polyamide wax, a solution of polyhydroxycarboxylic acid amides, and fumed silica treated with polydimethylsiloxane.

In one preferred embodiment of the present invention, the thixotropic filler system includes: (1) ground calcium carbonate (20-29 Wt. %), (2) coated calcium carbonate (5-10 Wt. %), and (3) polyamide wax (1-2 Wt. %), or (4) fumed silica treated with polydimethylsiloxane (1-2 Wt. %). This weight percent is of the total weight of the composition.

In another embodiment of the present invention, the thixotropic filler system includes: from approximately 0.1 percent to approximately 10.0 percent of at least one nano clay thixotropic agent, a polyamide wax, treated silica, coated calcium carbonate, and at least one liquid rheological additive (e.g., BYK 430, 431, R 605 and Crayvallac LA 150, 250).

Preferably, the thixotropic filler system is present from approximately (i.e., +/−5%) 10.0 percent to approximately (i.e., +/−5%) 45.0 percent of the total weight of the composition, and more preferably present from approximately (i.e., +/−5%) 20.0 percent to approximately (i.e., +/−5%) 30.0 percent of the total weight of the composition.

In a preferred implementation of the present invention, the one-component anti-flutter composition may further include a solvent, a rheology modifier, and/or an adjunct agent.

In accordance with the present invention, the one-component anti-flutter composition is characterized by, includes the properties of, and/or enables: (1) a composition having an expansion ratio that ranges from approximately 10 percent to approximately 300 percent, a lap shear strength ranging from approximately 0.1 to approximately 4.0 Mpa, and/or a mode of failure of 100% CF; (2) a rheometer viscosity ranging from approximately 500 to approximately 1,800 Pa·s. at STP; (3) a Sag resistance of less than 3 mm; (4) high wash resistance (i.e., no material is displaced/splattered from its original place as viewed by a human at less than three feet with no magnification); (5) the E-coat compatibility performance is without material contamination and crater free; (6) is capable of being exposed to aqueous liquid rinses after being applied to the surface of substrate 112/114 (See FIG. 2) and prior to being cured, without displacement from its original position and/or surface modification; and/or (7) expands and cures at temperatures below 350° F.

### Property Comparison

### Thixotropic Filler Physical Properties Comparison

| | Coated | Ground | Polyamide | Liquid Rheological | | Treated |
|---|---|---|---|---|---|---|
| Properties | CaCO₃ | CaCO₃ | Wax | Additive | MMT Clay | Silica |
| Surface Area | 18-25 | N/A | N/A | N/A | N/A | 100-200 |
| m²/g | | | | | | |
| Particle | 7-15 | 20-50 | <15 | N/A | 25-40 | 7-12 |
| Size(micron) | | | | | | |
| Surface | Stearic | None | Organically | N/A | Organically | polydimethyl- |
| Treatment | acid | | modified | | modified | siloxane |
| Paste Viscosity | 75 Pa · s | 5 Pa · s | 10 Pa · s | 4 Pa · s | 12 Pa· s | 100 Pa · s |
| 100 g DINP/ | | | | | | |
| 20 g filler | | | | | | |

### Tests/Experiments

TABLE 1
Compounding Ingredients

| Ingredients | Exp 1 | Exp 2 | Exp 3 | Exp 4 | Exp 5 | Exp 6 |
|---|---|---|---|---|---|---|
| Rubber/Elastomer Base | 15 | 15 | 15 | 15 | 15 | 15 |
| PVC resin | 12 | 12 | 12 | 12 | 12 | 12 |
| Blowing agent | 1 | 1 | 1 | 1 | 1 | 1 |
| Plasticizer | 32 | 32 | 32 | 32 | 32 | 32 |
| Curing agents (Various) | 5 | 5 | 5 | 5 | 5 | 5 |
| Adhesion promoter | 4.0 | 4.0 | 4.0 | 4.0 | 4.0 | 4.0 |
| Pigment | 1.50 | 1.50 | 1.5 | 1.5 | 1.5 | 1.5 |
| Wetting agent | 0.5 | 0.5 | 0.5 | 0.5 | 0.5 | 0.5 |
| Ground CaCO3 | 24 | 23 | 23 | 20 | 21 | 29 |
| Coated CaCO3 | 5.0 | 5 | 5 | 6 | 8 | 0 |
| MMT clay | 0.5 | 0 | 0 | 0 | 0 | 0 |
| Poly amide wax | 0 | 0 | 0 | 1 | 0 | 0 |
| Liquid rheological | 0 | 0.5 | 0 | 0 | 0 | 0 |
| additive | | | | | | |
| Treated fumed Silica | 0 | 0.5 | 1 | 0 | 0 | 0 |
| Total | 100 | 100 | 100 | 100 | 100 | 100 |

TABLE 2
Test Results

| Test results | | Exp 1 | Exp 2 | Exp 3 | Exp 4 | Exp 5 | Exp 6 |
|---|---|---|---|---|---|---|---|
| Viscosity (Pa · s) | | 1250 | 1021 | 1601 | 1392 | 906 | 791 |
| Adhesion | | 100 | 100 | 100 | 100 | 100 | 80 |
| (% Cohesive failure) | | | | | | | |
| Sag resistance (mm) | | 0 | 0 | 0 | 0 | 3 | 20 |
| Wash | Rotational | No bead | No bead | No Bead | No bead | Bead | Bead |
| resistance | | movement | movement | movement | movement | distortion | distortion |
| | Direct | Slight bead | Very slight | No bead | No bead | Bead | Bead |
| | impingement | distortion | bead | distortion | distortion | distortion | distortion |
| | | | distortion | | | | |

| | | | | | | |
|---|---|---|---|---|---|---|
| E coat compatibility (Crater) | No crater | No crater | No crater | No crater | No crater | No crater |

TABLE 3
Pressure Flow Viscosity vs Temperature

| | Viscosity (Sec) | | | | | |
|---|---|---|---|---|---|---|
| | (80 psi, 20 g, 2.6 mm orifice) | | | | | |
| Temperature | Exp 1 | Exp 2 | Exp 3 | Exp 4 | Exp 5 | Exp 6 |
| 25° C. | 70 | 70 | 82 | 77 | 64 | 40 |
| 35° C. | 51 | 49 | 67 | 58 | 39 | 12 |

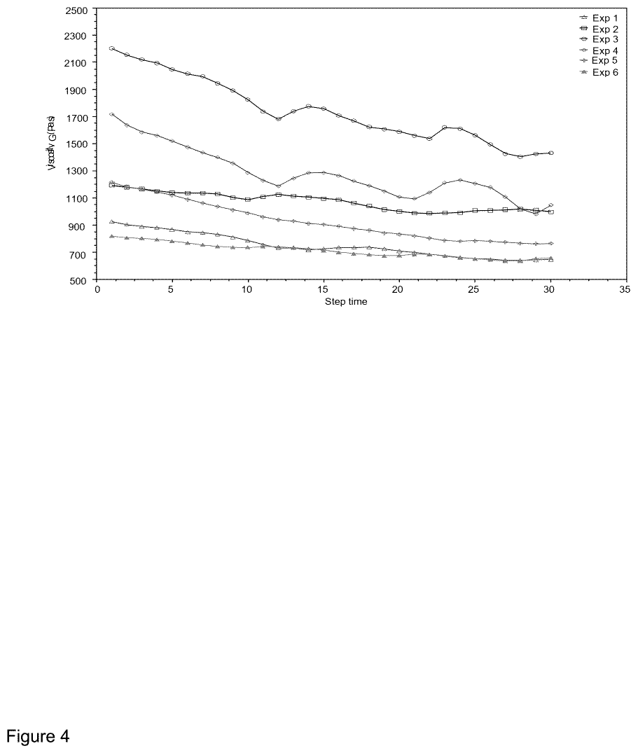

Viscosity—Rotational Measurements. See FIG. 4. (Low shear rate, 40 mm plate, 1.5 shear rate, 5 min, 1000-micron gap at room temperature (25° C.)).

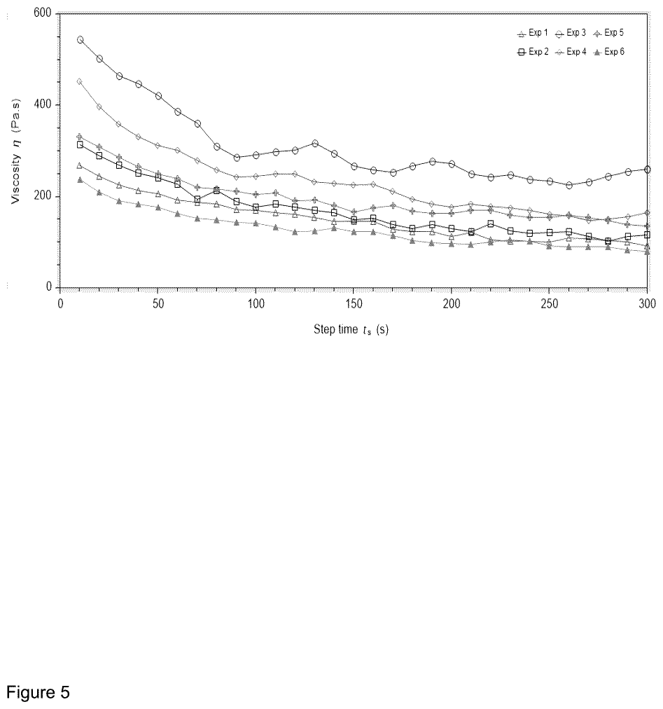

Viscosity—Rotational Measurements. See FIG. 5. (High shear rate, 40 mm plate, 10.0 shear rate, 5 min, 1000-micron gap at room temperature (25° C.)).

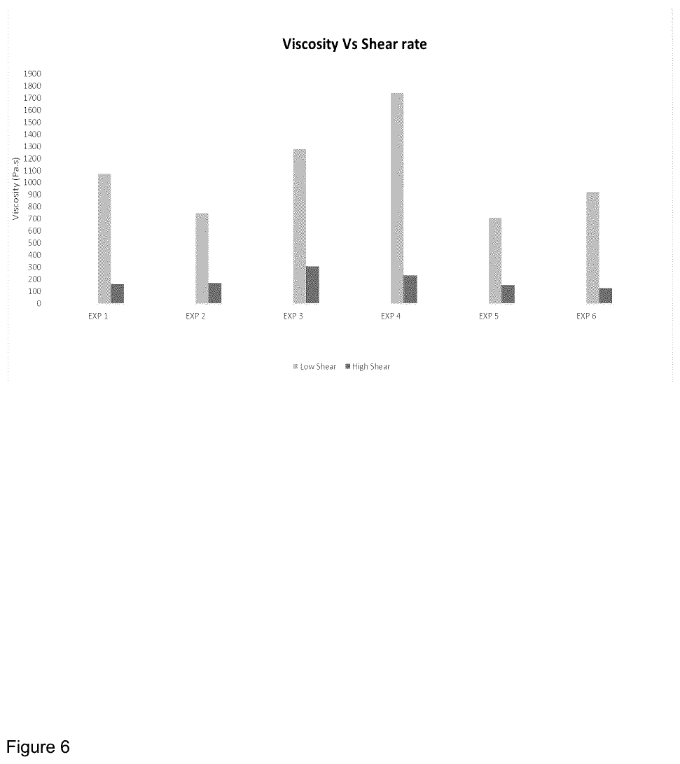

TABLE 4
Comparison of viscosity at low and high shear rates at
room temperature (25° C.) based on data from FIGS. 4-6.

Viscosity (Pa · s)

| | Low shear | High shear |
|---|---|---|
| Experiment | rate | rate |
| Exp 1 | 749 ± 89 | 160 ± 48 |
| Exp 2 | 1073 ± 5 | 170 ± 57 |
| Exp 3 | 1741 ± 237 | 309 ± 86 |
| Exp 4 | 1278 ± 187 | 234 ± 77 |
| Exp 5 | 926 ± 143 | 155 ± 50 |
| Exp 6 | 713 ± 54 | 128 ± 40 |

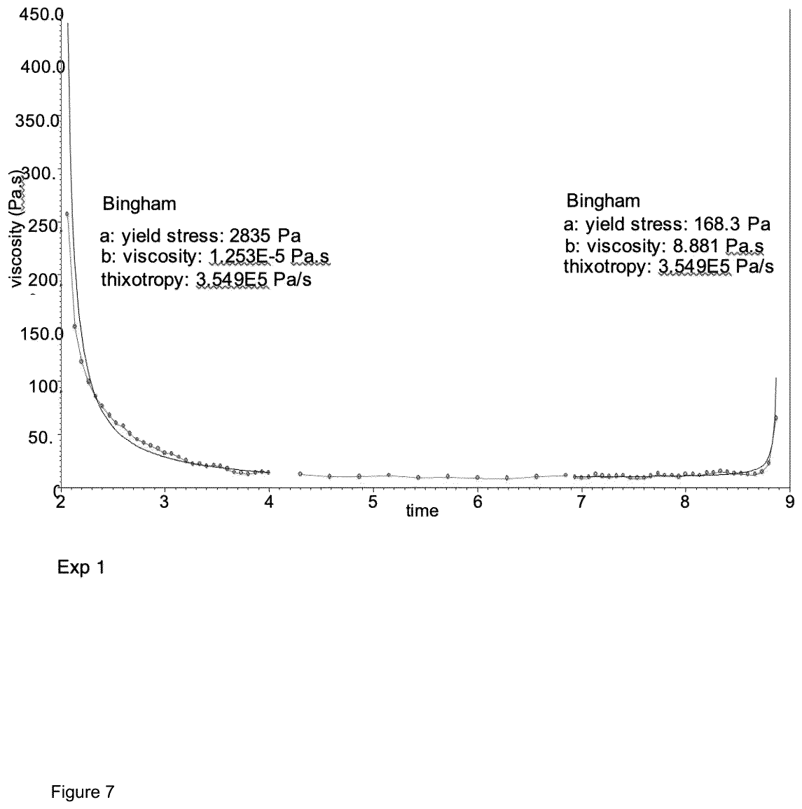

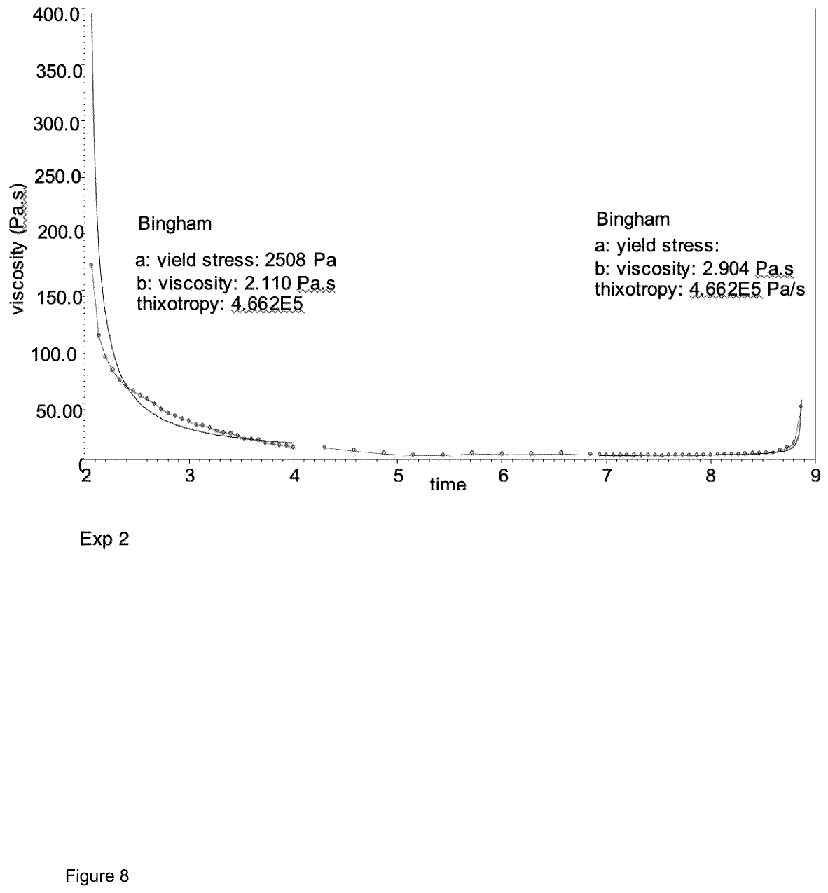

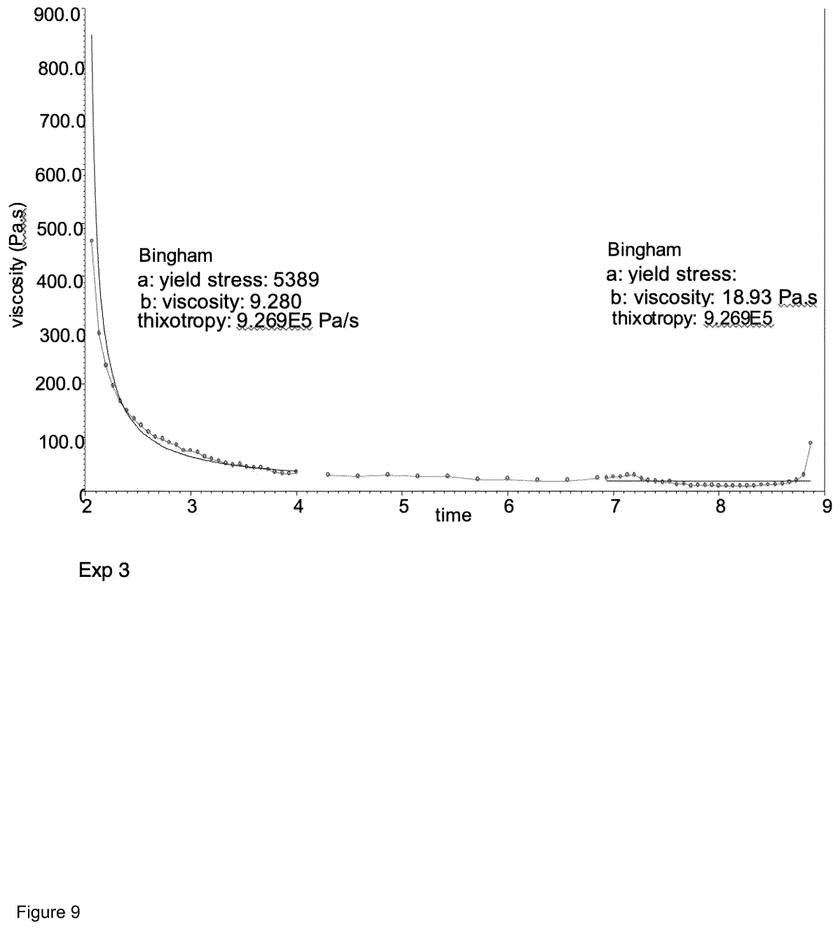

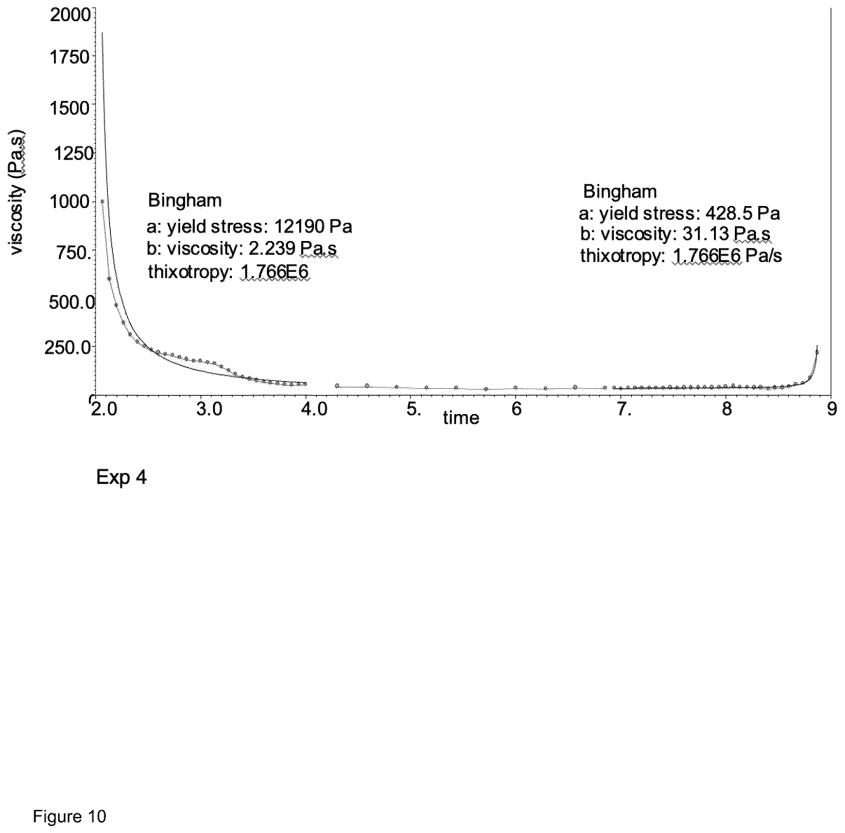

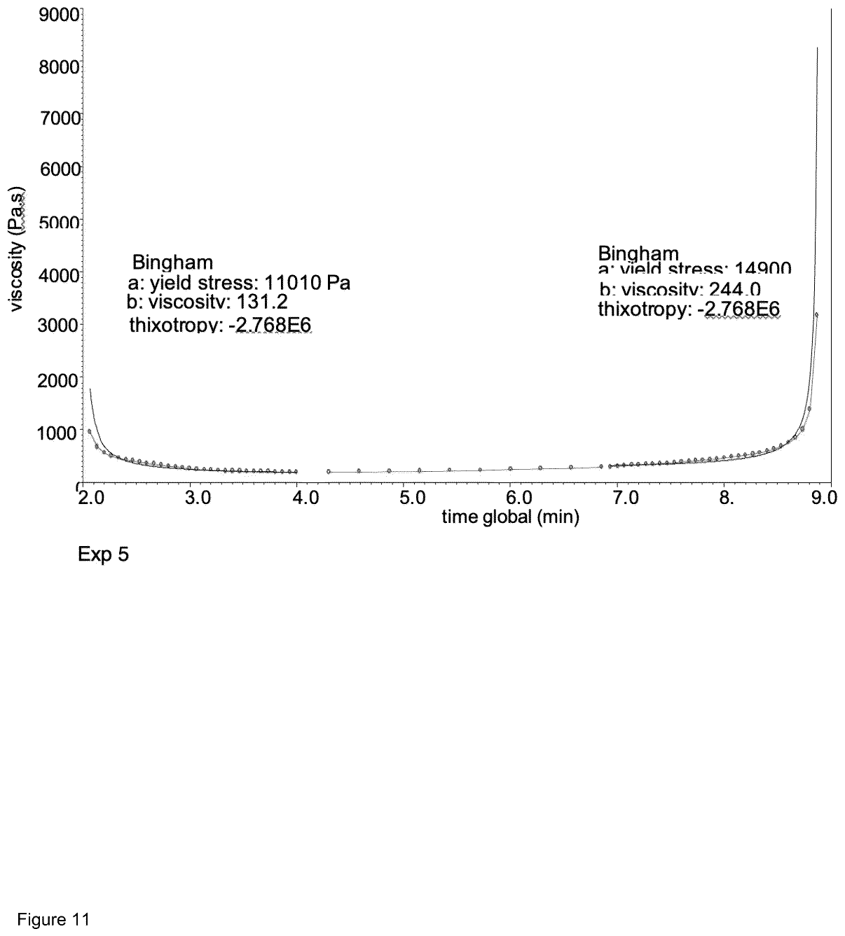

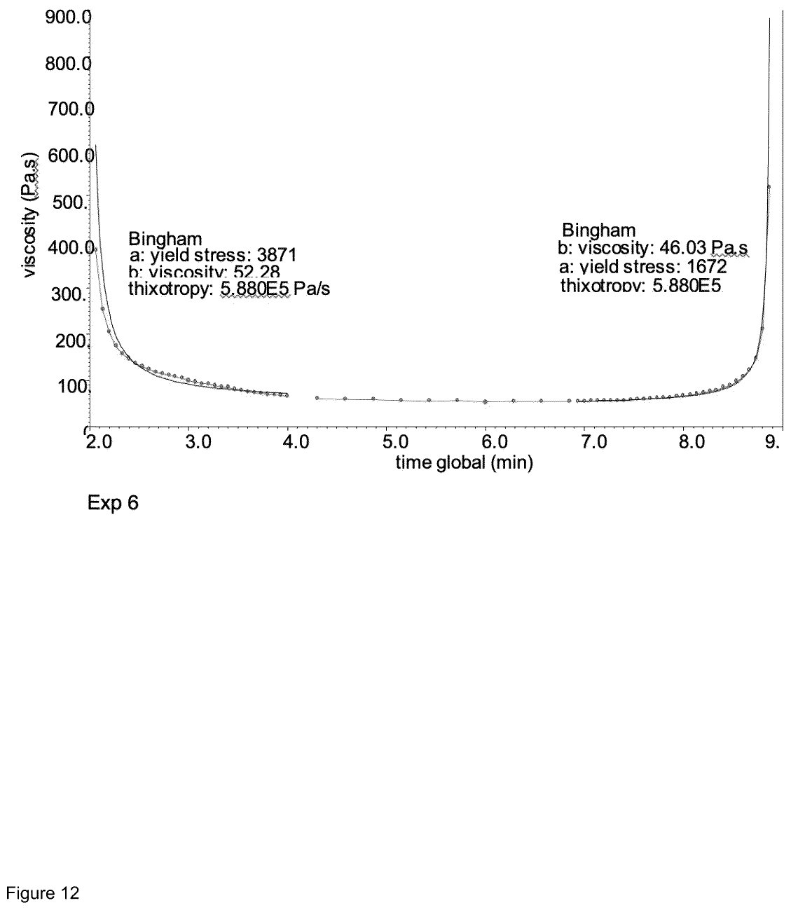

FIGS. 7-12 are two-dimensional graphs showing viscosity as a function of time, via oscillational measurement, for Experiments 1-6, respectively.

### Storage Modulus

The storage modulus determines the solid-like character of a polymer. When the storage modulus is high, the more difficult it is to break down the sealer rheology, which makes it more difficult to force through a nozzle extruder. However, the sealer with the highest storage modulus will also be the most stable after pass through pretreatment during the OEM body shop process.

The reverse is true for a low storage modulus. In this case, the polymer is too liquid-like and may begin to drip out of the nozzle, and may not hold its shape very well. A similar parameter is loss modulus, which is the opposite of storage modulus, the polymer's liquid-like character. When storage modulus is high, loss modulus is low, and vice-versa.

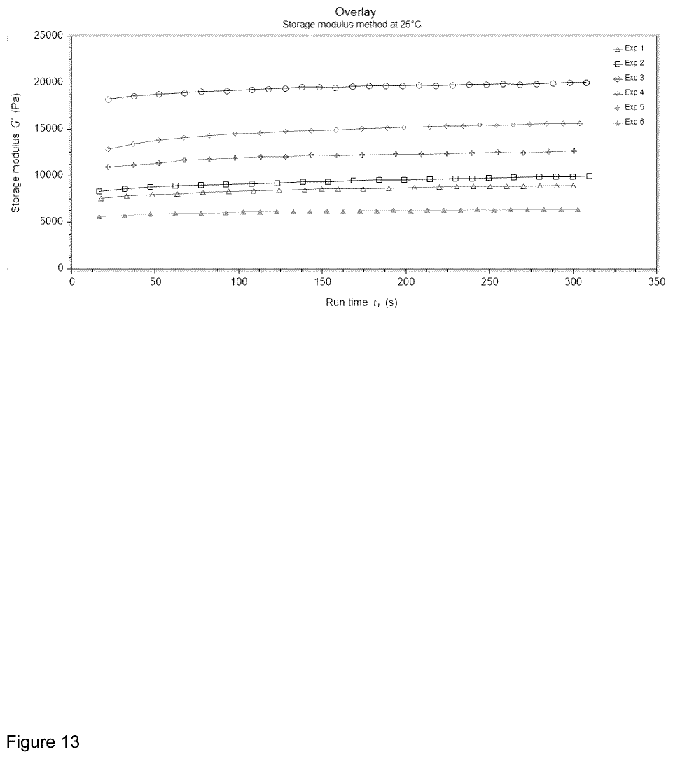

Polymers with a storage modulus greater than their loss modulus are preferred, as it provides a material that will hold its shape while still being able to be extruded. Storage and loss modulus also determine how soon a polymer will begin to break down with added force. Storage modulus results for Experiments 1-6 are provided in FIG. 13.

### Sag Resistance

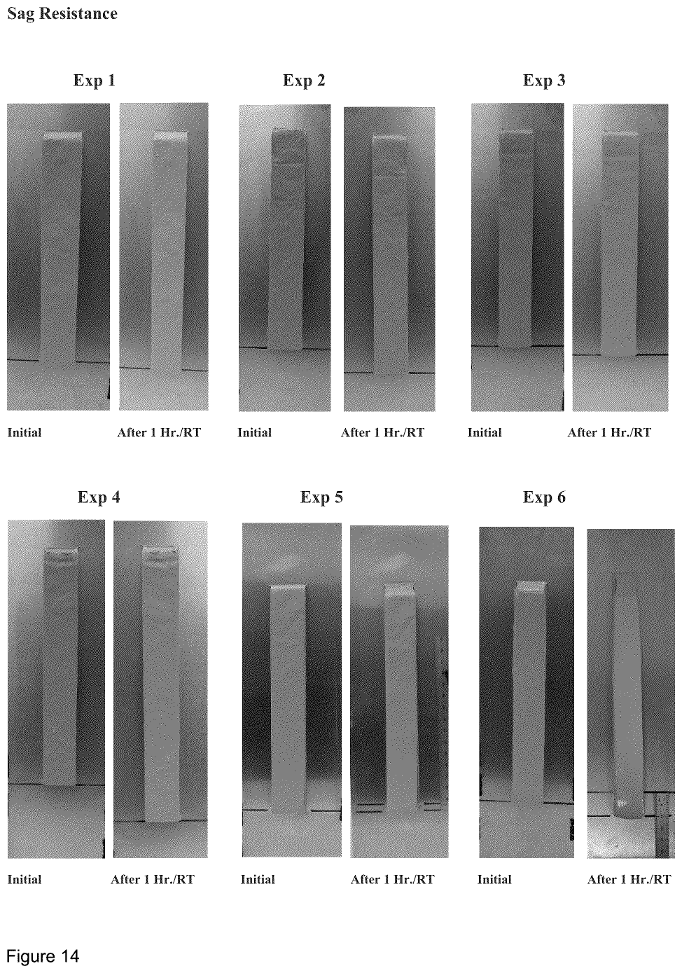

FIG. 14 are photographs showing Sag resistance (time 0 and time 60 minutes at STP) for Experiments 1-6.

### Sealer Wash Resistance Performance (Rotational Method)

### Experimental Conditions and Setup.

Fill the water into a Round or Rectangular bath to a depth sufficient to completely cover the material bead on a test panel. Bring the water up to astable temperature of 60 C.

Using a cartridge gun, apply a 6-8 mm diameter and 100 mm long bead of material in to 50 mm by 150 mm oily metal panel.

Attach “test samples” to the test rig and attach the test rig with applied test samples to the stirrer. Up to 3 “test samples” can be attached to the test rig and run at the same time. If less than 3 samples are attached, “test blanks” need to be attached to the rig in place of any missing sample in order to keep the rig balanced during the test. Immerse test rig with samples attached, into the water bath. Make sure that sample material is completely submerged under the water. Insure that the direction of rotation has the water flowing through the sample, past the bolts before impinging the material bead, Set rotation speed of the stirrer and turn on. Allow to run for 3 minutes. The test shall be conducted at rotational speeds at 140 RPM.

At the completion of the 3 minutes, turn off the stirrer and remove the test rig with samples. Detach test samples from the rig and inspect for any movement or wash out of the material from between the panels.

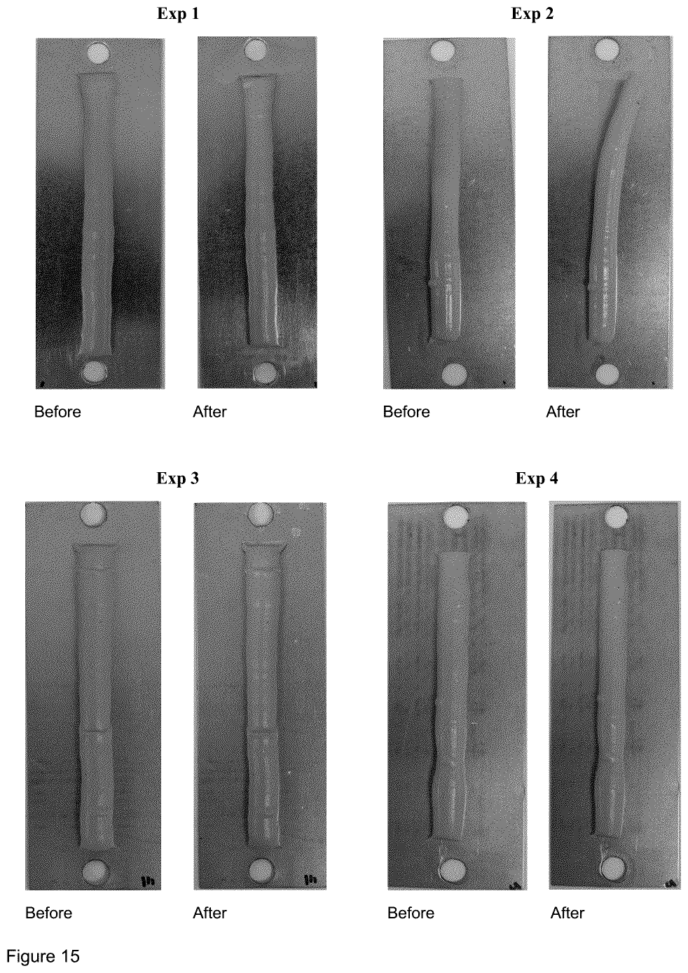

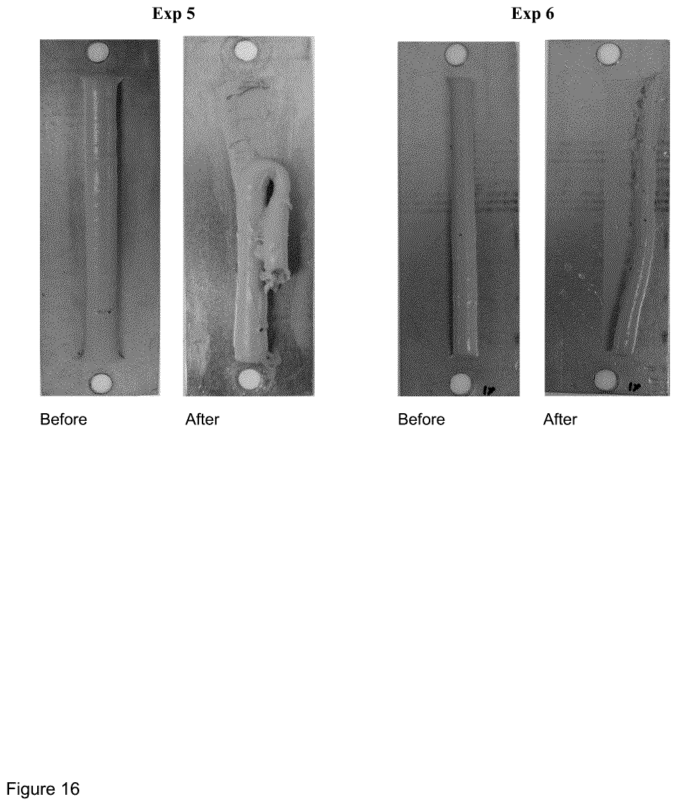

FIGS. 15-16 are photographs showing wash resistance performance using the rotational method for Experiments 1-6.

### Sealer Wash Resistance Performance (Direct Impingement Spray)

### Experimental Conditions and Setup.

This method also tests for wash off resistance. The wash off resistance was conducted with a spray tank designed for adhesive wash off testing. A 40040 flat spray nozzle 40° wide angle spray nozzle that provided a Flat spray pattern was used. The nozzle orifice was 1.016 mm diameter. The water temperature was maintained at 30-60° C. and maintaining minimum pressure of 20 psi at the outlet nozzle when used in conjunction with the type of nozzle specified. A 25 mm width and 200 mm long adhesive ribbon was applied to a 100 cm by 300 cm CRS oily steel panel. The initial ribbon position was pre-marked allowing for measurement of any ribbon due to spray. The spray water was aimed at the panel such that the water fan was 90° angle to the area that was the center of the bead. The waster fan was approximately 20.3 cm wide at point of contact angle with the panel. The nozzle was maintained for 120 seconds at these conditions.

The ribbon movement was measured in mm at 3 locations, 25 mm from the ends in the middle. An average of displacement was taken from these 3 values. The width of the bead and other measurements were taken after the test was completed using a micrometer.

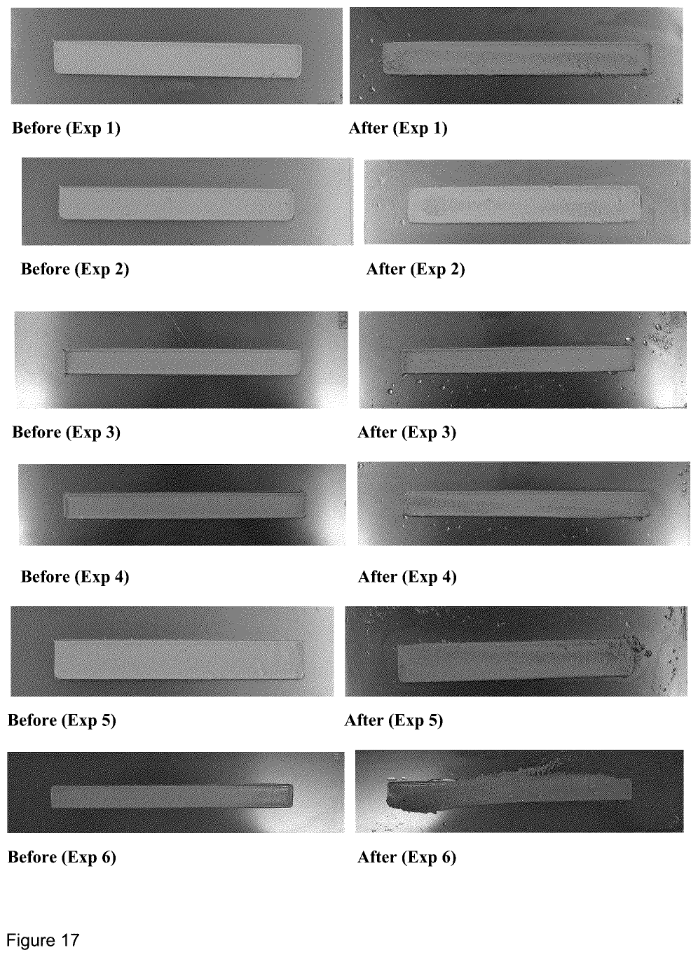

FIG. 17 are photographs showing wash resistance performance using direct impingement spray for Experiments 1-6.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and Desired to be Secured by Letters Patent of the United States is:

1. A pumpable, one-component, curable, anti-flutter composition which cures to form a cured product, comprising:
an elastomer;
a homopolymer resin;
a novel thixotropic filler system; and
wherein the anti-flutter composition exhibits high wash resistance.

2. A cured product formed using the one-component, anti-flutter composition according to claim 1.

3. A pumpable, one-component, curable, anti-flutter composition which cures to form a cured product, comprising:
an elastomer;
a PVC resin;
a blowing agent;
a plasticizer;
a curing agent;
an adhesion promoter;
an optional pigment;
a wetting agent;
a thixotropic filler system; and
wherein the anti-flutter composition exhibits high wash resistance.

4. The anti-flutter composition according to claim 3, wherein the elastomer comprises a styrene-butadiene rubber present from approximately 5.0 percent to approximately 30.0 percent of the total weight of the composition.

5. The anti-flutter composition according to claim 3, wherein the elastomer comprises a crosslinked styrene-butadiene rubber terpolymer present from approximately 5.0 percent to approximately 30.0 percent of the total weight of the composition.

6. The anti-flutter composition according to claim 3, wherein the PVC resin is present from approximately 5.0 percent to approximately 20.0 percent of the total weight of the composition.

7. The anti-flutter composition according to claim 3, wherein the blowing agent comprises at least one of azodicarbonamide and methyl cyanoacrylate present from approximately 0.1 percent to approximately 5.0 percent of the total weight of the composition.

8. The anti-flutter composition according to claim 3, wherein the plasticizer is represented by at least one of the following chemical structures and derivatives thereof:

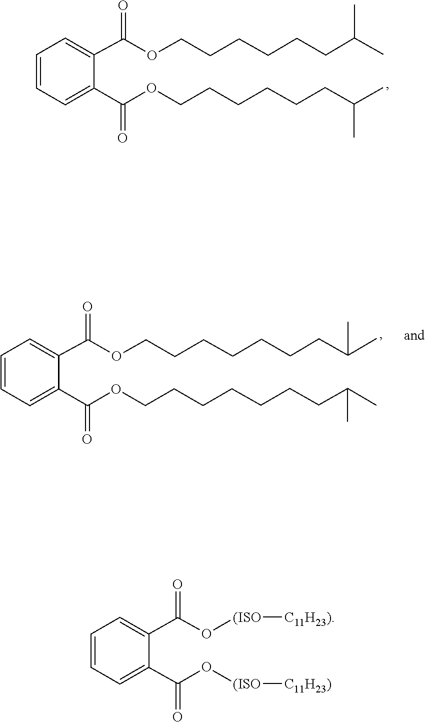

9. The anti-flutter composition according to claim 8, wherein the plasticizer is present from approximately 10.0 percent to approximately 45.0 percent of the total weight of the composition.

10. The anti-flutter composition according to claim 3, wherein the curing agent comprises a substituted urea present from approximately 1.0 percent to approximately 10.0 percent of the total weight of the composition.

11. The anti-flutter composition according to claim 4, wherein the adhesion promoter comprises a bisphenol A liquid epoxy resin present from approximately 1.0 percent to approximately 10.0 percent of the total weight of the composition.

12. The anti-flutter composition according to claim 11, wherein the adhesion promoter comprises a bisphenol A diglycidyl ether epoxy resin represented by the following chemical structure and derivatives thereof: 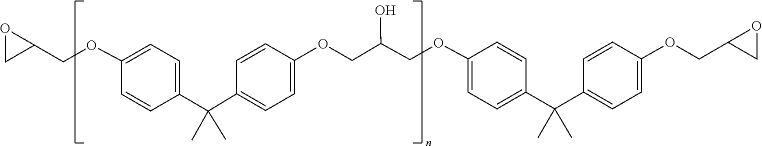
wherein n is 0 or an integer ranging from 1 to approximately 25.

13. The anti-flutter composition according to claim 3, wherein the optional pigment comprises titanium dioxide present from approximately 0.1 percent to approximately 5.0 percent of the total weight of the composition.

14. The anti-flutter composition according to claim 3, wherein the wetting agent comprises at least one of the following petroleum distillates, poly(oxy-1,2-ethanediyl)-alphas-(3-carboxy-1-oxypropyl)-omega-(tridecyloxy)-(acidic ester), and poly(oxy-1,2-ethanediyl)-alphas-(3-carboxy-1-oxypropyl)-omega (penta-decyloxy)-(acidic ester) present from approximately 0.1 percent to approximately 5.0 percent of the total weight of the composition.

15. The anti-flutter composition according to claim 3, wherein the thixotropic filler system comprises at least one of the following ground calcium carbonate, coated calcium carbonate, multi-mineral clay, polyamide wax, a solution of polyhydroxycarboxylic acid amides, and fumed silica treated with polydimethylsiloxane.

16. The anti-flutter composition according to claim 3, wherein the thixotropic filler system is present from approximately 10.0 percent to approximately 45.0 percent of the total weight of the composition.

17. A pumpable, one-component, curable, anti-flutter composition which cures to form a cured product, comprising:
an elastomer, wherein the elastomer comprises a styrene-butadiene rubber present from approximately 5.0 percent to approximately 30.0 percent of the total weight of the composition;
a PVC resin, wherein the PVC resin is present from approximately 5.0 percent to approximately 20.0 percent of the total weight of the composition;
a blowing agent, wherein the blowing agent comprises at least one of azodicarbonamide and methyl cyanoacrylate present from approximately 0.1 percent to approximately 5.0 percent of the total weight of the composition;
a plasticizer, wherein the plasticizer comprises diisononyl phthalate (DINP) present from approximately 10.0 percent to approximately 45.0 percent of the total weight of the composition;
a curing agent, wherein the curing agent comprises a substituted urea present from approximately 1.0 percent to approximately 10.0 percent of the total weight of the composition;
an adhesion promoter, wherein the adhesion promoter comprises a bisphenol A liquid epoxy resin present from approximately 1.0 percent to approximately 10.0 percent of the total weight of the composition;
a pigment, wherein the pigment comprises titanium dioxide present from approximately 0.1 percent to approximately 5.0 percent of the total weight of the composition;
a wetting agent, wherein the wetting agent comprises at least one of the following petroleum distillates, poly(oxy-1,2-ethanediyl)-alphas-(3-carboxy-1-oxypropyl)-omega-(tridecyloxy)-(acidic ester), and poly(oxy-1,2-ethanediyl)-alphas-(3-carboxy-1-oxypropyl)-omega-(pentadecyloxy)-(acidic ester) present from approximately 0.1 percent to approximately 5.0 percent of the total weight of the composition;
a thixotropic filler system, wherein the thixotropic filler system comprises the following: ground calcium carbonate, coated calcium carbonate, multi-mineral clay, polyamide wax, a solution of polyhydroxycarboxylic acid amides, and fumed silica treated with polydimethylsiloxane, and wherein the thixotropic filler system is present from approximately 10.0 percent to approximately 45.0 percent of the total weight of the composition; and
wherein the anti-flutter composition exhibits high wash resistance.

18. A cured product formed using the one-component, anti-flutter composition according to claim 17.
